(19) United States
(12) Patent Application Publication
(10) Pub. No.: US 2020/0391420 A1
(43) Pub. Date: Dec. 17, 2020

(54) CONTAINER WITH LID HAVING FLUORINATED POLYMER INTERNAL SURFACE AND METHODS FOR MAKING THE SAME

(71) Applicant: CSP TECHNOLOGIES, INC., Auburn, AL (US)

(72) Inventors: Franklin Lee Lucas, JR., Auburn, AL (US); William Frederick Spano, Auburn, AL (US); James S. HOLLINGER, Auburn, AL (US); Jason Pratt, Auburn, AL (US)

(21) Appl. No.: 16/772,198

(22) PCT Filed: Dec. 14, 2018
(86) PCT No.: PCT/US2018/065729

§ 371 Date: Jun. 12, 2020

Related U.S. Application Data
(60) Provisional application No. 62/598,994, filed on Dec. 14, 2017.

(51) Int. Cl. B29C 45/14; B65D 25/14; B65D 43/16; B65D 50/04; B65D 65/40; B32B 7/12; B32B 27/08

(52) U.S. Cl. CPC B29C 45/14688; B29C 45/14811; B29C 45/14311; B65D 25/14; B65D 43/162; B29K 2027/12; B65D 65/40; B32B 7/12; B32B 27/08; B29C 2045/14918; B29C 2045/14319; B65D 50/046

(57) ABSTRACT

Containers and methods for making and using the same are disclosed. The containers include internal fluoropolymer surfaces, optionally comprising fluorinated ethylene propylene (FEP), within the storage compartments. Such fluoropolymer surfaces may be incorporated into the containers via in-mold labeling, for example. Optionally, the containers are useful for storing cannabis extracts that are typically sticky. Low surface energy of the robust fluoropolymer surfaces in such containers help to prevent adherence of the sticky products to the container surfaces.

### BACKGROUND OF THE INVENTION

### 1. Field of Invention

This disclosure relates to packaging and methods for making containers that provide non-stick surfaces within the storage compartments of the containers. More particularly, this disclosure describes packaging incorporating fluoropolymer surfaces (e.g., from fluorinated ethylene propylene) within the storage compartments of containers and methods to overcome challenges associated with providing such surfaces.

### 2. Description of Related Art

Products that are sticky or tacky can be difficult to remove from packaging since such products may tend to adhere to surfaces within the storage compartment of the packaging. It may be helpful to provide storage compartment surfaces with low surface energy, e.g., at or below 24 dynes/cm², to reduce or eliminate adherence of sticky products to the surfaces. However, there are challenges associated with providing such surfaces.

Plastics packaging is being provided for the nascent legal cannabis market within certain jurisdictions in the United States. Some cannabis extracts can be sticky or tacky. For example, “shatter” and “wax” are types of cannabis extracts that have a consistency and tackiness somewhat akin to the outside of a candied apple. Storing cannabis shatter or other such extract in a plastic package with straight polypropylene or polyethylene storage compartment surfaces, would render the product very difficult to extract from the package. Moreover, if one succeeds in extracting such product, it is likely to leave behind portions of the product, residue or other markings on the inside of the package.

Fluorinated ethylene propylene, or FEP, is a polymer with a very low surface energy, which has excellent non-stick or low-stick properties. FEP was well known for years under a DuPont brand TEFLON FEP, which was used, e.g., for non-stick applications for cookware. FEP would be a good option for storing sticky contents (e.g., cannabis shatter) in packaging. However, conventional FEP materials are not readily incorporated into rigid containers. One such conventional material, for example, is FEP tape, which includes an FEP surface and an adhesive side. However, such tape is not configured for in-line package production and would tend to wrinkle and/or lay unevenly on contoured surfaces of polymer packaging.

FEP has one of the lowest surface energies of plastics. This makes it ideal as a non-stick layer. However, for that same reason, FEP does not readily bond to surfaces without surface treatment, e.g., plasma or corona treatment. Even with treatment, lamination or mechanical fastening is usually required, which injects an additional challenge to incorporating FEP in a cost effective and physically robust manner, into rigid packaging.

There thus exists a need for rigid packaging that incorporates FEP or other fluoropolymer materials into an internal storage compartment on contoured surfaces in such a way that the FEP would not wrinkle, particularly at junctures between storage compartment surfaces. There further exists a need for methods for incorporating FEP onto the storage compartment surfaces that provides a robust FEP layer to provide storage compartment surfaces with low surface energy for non-stick or low-stick applications.

### BRIEF SUMMARY OF THE INVENTION

Accordingly, in one aspect, a container is provided. The container includes a body having a base and sidewalls extending upwards from the base leading to an opening. The base and sidewalls form a storage compartment adapted to house product. The storage compartment has interior surfaces. A lid is provided, which is optionally linked to the body by a hinge. The lid is configured to cover the opening to enclose the storage compartment. The lid has at least one interior surface. A layer of fluorinated ethylene propylene (FEP) covers an entirety of each of the interior surfaces. The container is preferably made of a rigid polymer.

Optionally, in any embodiment, the FEP layer(s) is provided on all product contacting surfaces of the storage compartment.

Optionally, in any embodiment, the FEP layer has a surface energy at or below 24 dynes/cm².

Optionally, in any embodiment, the container is used to store cannabis extract, optionally shatter or other sticky substances.

In another aspect, an in-mold labeling method for applying a fluoropolymer layer to an inside of a container is provided. The method includes providing a body label inside a mold, the body label having a first side and a second side opposite the first side. The first side has an outer fluoropolymer surface of a fluoropolymer layer. The second side has a polymer bonding surface of a polymer layer adapted to contact and bond with a compatible polymer substrate upon application of sufficient heat to the polymer bonding surface and/or polymer substrate followed by cooling. The body label further includes a tie layer between the fluoropolymer layer and polymer layer. The in-mold labeling method further includes injecting molten thermoplastic resin into the mold to form a container comprising a body having a base and sidewalls extending upwards from the base leading to an opening. The base and sidewalls form an interior space having an internal storage space adapted to house product. The storage space has at least one interior surface. The method further includes a step of, in the mold, applying the bonding surface of the body label to the at least one interior surface. Through sufficient heating of the bonding surface and/or the at least one interior surface of the storage space followed by cooling, the body label is caused to bond to the at least one interior surface of the storage space. Upon cooling, the body label is permanently bonded to the interior surface of the storage space and the body is solid and rigid.

Optionally, in any embodiment, the container further includes a lid configured to cover the opening when the container is in a closed position. Optionally, in any embodiment, the lid includes at least one interior surface that encloses the storage space to form a fully encapsulated storage compartment when the container is in the closed position. A lid label may be provided inside the mold or a second mold (i.e., the lid may be made in the same mold as the body or alternatively in a different mold and then subsequently assembled with the body, if desired). The lid label has a first side and a second side opposite the first side. The first side includes an outer fluoropolymer surface of a fluoropolymer layer. The second side includes a polymer bonding surface of a polymer layer adapted to contact and bond with a compatible polymer substrate upon application of sufficient heat to the polymer bonding surface and/or polymer substrate followed by cooling. The lid label further includes a tie layer between the fluoropolymer layer and polymer layer. In the mold or the second mold in which the lid label is provided, the bonding surface of the lid label is applied to the at least one interior surface of the lid. Through sufficient heating of the bonding surface and/or the at least one interior surface of the lid space followed by cooling, the lid label is caused to bond to the at least one interior surface of the lid. Upon cooling, the lid label is permanently bonded to the interior surface of the lid and the lid is solid and optionally rigid.

In any embodiment, if there is a lid, the lid is optionally linked to the body by a hinge.

Optionally, in any embodiment, the fluoropolymer layer of the body label and/or lid label comprises fluorinated ethylene propylene (FEP).

Optionally, in any embodiment, the tie layer adheres to the fluoropolymer layer and to the bonding layer, effectively joining them to form the label.

Optionally, in any embodiment, the tie layer includes a double coated polymer film and a synthetic rubber-based adhesive.

Optionally, in any embodiment, the polymer layer includes a polymer material that is compatible with a polymer material of the interior surface so as to facilitate bonding of the label to the interior surface through heating the bonding surface and/or the at least one interior surface.

Optionally, in any embodiment, the body label is permanently bonded to the at least one interior surface of the storage space and/or the lid label is permanently bonded to the at least one interior surface of the lid, without the presence of an adhesive between a respective label and a respective surface.

Optionally, in any embodiment, the step of injecting molten thermoplastic resin into the mold to form a container is performed after the step of providing a body label inside the mold.

Optionally, in any embodiment, the body label and lid label together cumulatively cover at least 90% of the interior surfaces, optionally at least 95% of the interior surfaces, optionally at least 98% of the interior surfaces, optionally all or substantially all interior surfaces, of the encapsulated storage compartment.

Optionally, in any embodiment, the at least one of the interior surfaces of the storage space includes a first interior surface and a second interior surface that meet at a juncture, wherein the body label overlays both the first interior surface and the second interior surface such that the label does not wrinkle at the juncture.

Optionally, in any embodiment, the fluoropolymer layer of the body label and/or lid label is 0.5-5 mils thick, optionally 1-3 mils thick, optionally 1-2 mils thick.

Optionally, a container is made according to the methods disclosed herein. Optionally, when the container is in a closed position, the body label and the lid label cover at least 95%, optionally at least 98%, optionally the entirety of the storage compartment. Optionally, a portion of the lid (e.g., a skirt) engages a portion of the body (e.g., sidewalls). This provides a seal for the storage compartment, so as to substantially isolate the storage compartment from the ambient environment. Optionally, the seal renders the storage compartment moisture tight. Optionally, the container may be used for storing cannabis extract. The cannabis extract may be sticky, such as a shatter or wax. The surface energy of the outer fluoropolymer surface of the fluoropolymer layer is at or below 24 dynes/cm², so as to provide a surface to which the extract does not adhere. The container may alternatively be used for other sticky products, e.g., confections. Preferably, removal of the extract or product from the storage compartment does not leave residue or other markings on the outer fluoropolymer surface of the fluoropolymer layer.

### BRIEF DESCRIPTION OF SEVERAL VIEWS OF THE DRAWINGS

The invention will be described in conjunction with the following drawings in which like reference numerals designate like elements and wherein:

FIG. 1 is an isometric view of an optional container according to an aspect of the disclosed concept, wherein the container is in a closed position.

FIG. 2 is an isometric view of the container of FIG. 1 in an opened position.

FIG. 3 is a section view of the container of FIG. 1.

FIG. 4 is an enlarged view of a portion of the section view of the container shown in FIG. 3 to illustrate a fluoropolymer label bonded to surfaces of a storage compartment thereof.

FIG. 5 is an isometric view of an alternative embodiment of a container in an opened position.

FIG. 6 is an isolated schematic isometric view of a fluoropolymer label according to an aspect of the disclosed concept.

### DETAILED DESCRIPTION OF PREFERRED EMBODIMENTS OF THE INVENTION

In any embodiment, the disclosed concept is directed to a package having rigid storage compartment surfaces, wherein the surfaces comprise a layer of a fluoropolymer, e.g., fluorinated ethylene propylene (FEP). Optionally, the FEP layer is provided as a component of a laminate, which may be applied to the package, for example, via an in-mold labeling process or pressure sensitive labeling process. Alternatively, the FEP layer is provided as a thermoformed composite comprising a polymer base layer (e.g., polypropylene) and FEP. Each of these embodiments and associated processes are now discussed in more detail.

### Exemplary Embodiments of Container and Label

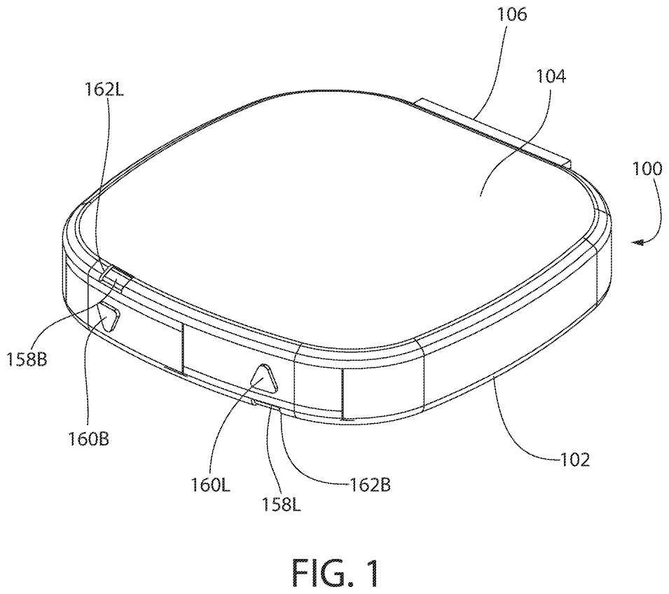

In any embodiment, a container is provided. Referring to FIGS. 1 to 4, there is shown an exemplary embodiment of a container 100 that may be used according to an optional aspect of the disclosed concept. The container 100 is preferably made from a rigid polymer, such as polypropylene.

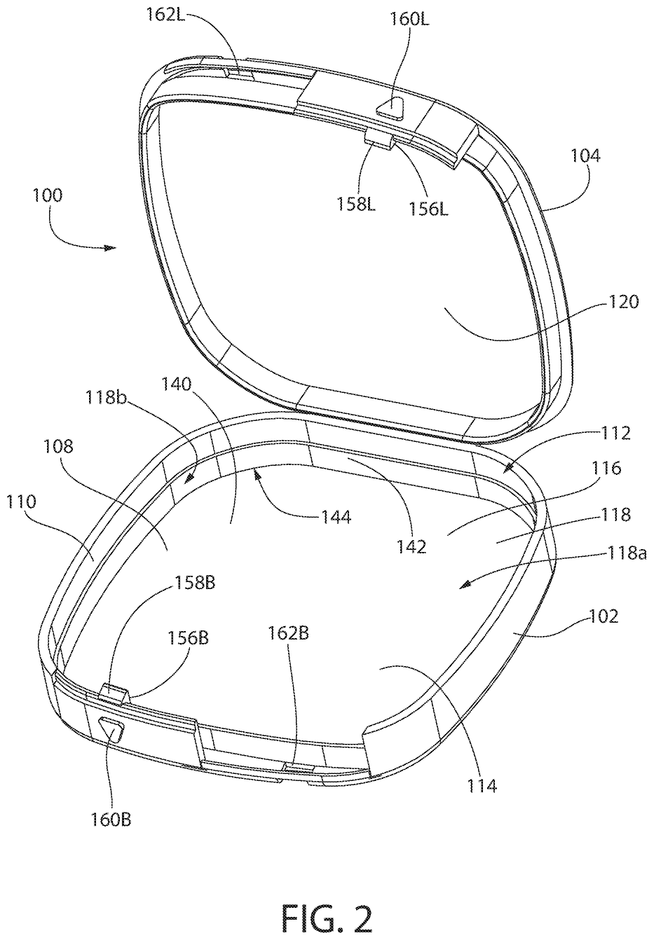

As shown, container 100 includes a preferably rigid body 102 and preferably a lid 104 that is optionally connected to the body 102 by a hinge 106. As shown in FIG. 2, body 102 includes a base 108 and sidewalls 110 extending upwards from the base 108 leading to an opening 112. The lid 104 is configured to cover the opening 112 when container 100 is in a closed position. The lid is preferably rigid, e.g., a rigid polymer material that may be the same as that of the body. Alternatively, the lid is flexible, e.g., a flexible polymer film or aluminum foil that is heat sealed about the opening.

The base 108 and sidewalls 110 form and surround an interior space 114. The interior space 114 comprises an internal storage space 116 adapted to house product. The storage space 116 has at least one interior surface 118. In the embodiment shown in FIGS. 1-4, the storage space 116 has a first interior surface 118a on the base 108 and a second interior surface 118b on the sidewalls 110. The sidewalls 110 extend from and are perpendicular to base 108. However, it should be understood that sidewalls need not necessarily be perpendicular to base in some embodiments and that other orientations are contemplated.

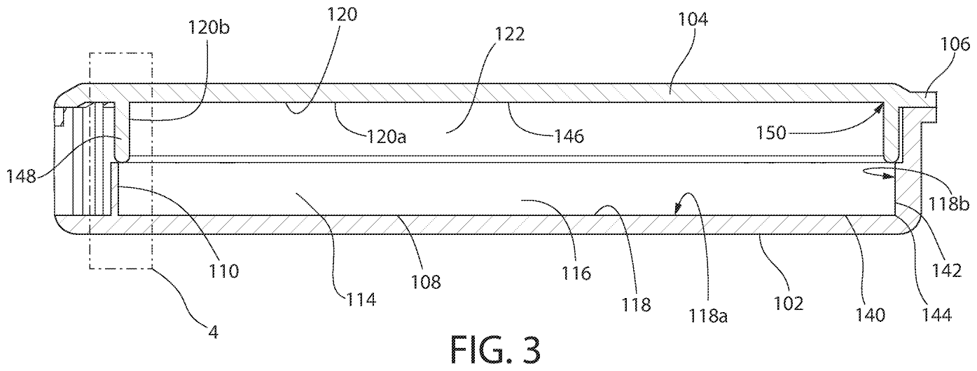

As shown in FIGS. 2 and 3, the lid 104 comprises at least one interior surface 120 that encloses the storage space 116 to form a fully encapsulated storage compartment 122 when container 100 is in the closed position. In this way, the respective interior surfaces 118, 120 together fully surround the entire space within the storage compartment 122 and would thus also fully surround any product stored therein.

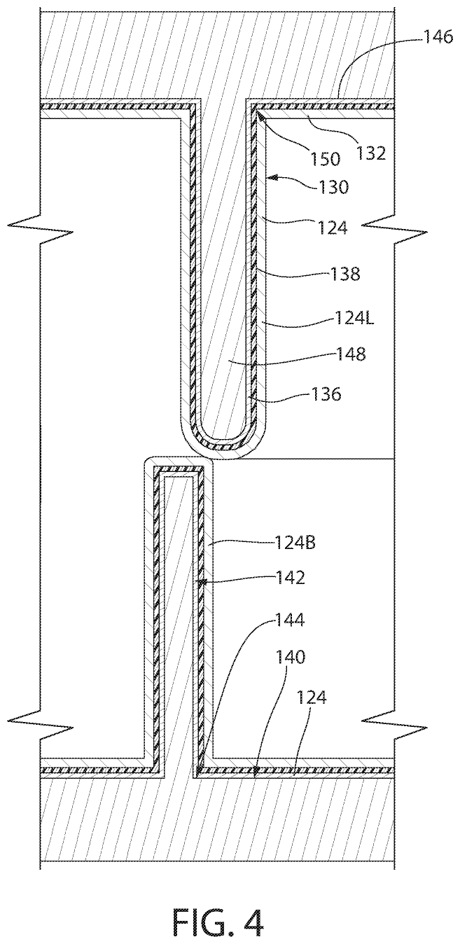

Referring to FIG. 4, the container 100 would also include preferably a fluoropolymer label 124 that is bonded to respective interior surfaces 118, 120 in the storage compartment 122. The label 124 is schematically depicted with exaggerated thickness for visual clarity in the figure. As will be discussed, such a label 124 may be applied to both the body 102 and lid 104. The composition and construction of the label 124 may optionally (albeit not necessarily) be identical for both the body 102 and lid 104. To the extent this specification discusses the lid label and body label separately, it is for the purpose of describing how a respective label is oriented with respect to a corresponding structure. To the extent this specification discuss the label generically (without reference to whether the label is part of the lid or body), it may be assumed (unless otherwise indicated) that the description applies to labels usable on both the lid and body.

The label 124 is optionally about 1 to 20 mils thick, optionally 2 to 15 mils thick, optionally 2 to 10 mils thick, optionally 3 to 8 mils thick, optionally, 4 to 6 mils thick. The label 124 may be applied to the container and/or lid, for example, by in-mold labeling or pressure sensitive labeling. Each of these processes are generally described below; first however, the structure a fluoropolymer (e.g., FEP) label 124 is now described.

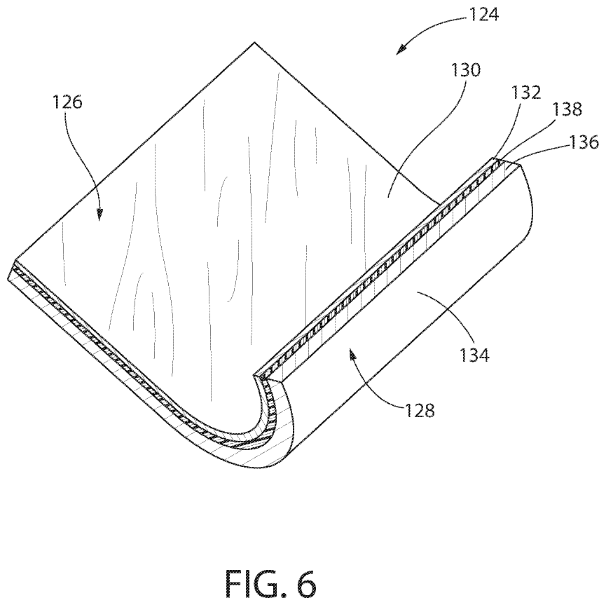

FIG. 6 shows an isolated schematic isometric view of a fluoropolymer label 124 according to an optional aspect of the disclosed concept. The thickness is exaggerated in order to clearly depict the positioning of the respective layers and surfaces. The label 124 has a first side 126 and a second side 128 opposite the first side 126. The first side 126 comprises an outer fluoropolymer surface 130 of a fluoropolymer layer 132. The second side 128 comprises a polymer bonding surface 134 of a polymer layer 136 adapted to contact and bond with an interior surface 118 of the storage space 116 or interior surface 120 of lid 104.

The fluoropolymer layer 132 preferably comprises FEP. The fluoropolymer layer 132 is optionally about 0.5-10 mils thick, optionally 0.5-5 mils thick, optionally, 1-3 mils thick, optionally 1-2 mils thick. A 1-2 mil thickness may be preferred because that thickness has been found to be sufficient for its intended purpose. Increasing the thickness of the fluoropolymer layer 132 beyond that may provide diminishing returns in light of the cost of FEP and other fluoropolymer materials. FEP's utility as a low surface energy layer is provided via its surface. That is, once the FEP is thick enough to provide a robust surface (e.g., at least 1 mil), additional thickness may not enhance its non-stick properties in any meaningful way. FEP is a relatively expensive material. Therefore, to provide a robust label, it would be preferred that the polymer bonding layer provide the desired thickness, since polymers such as polypropylene are much less expensive than FEP.

While FEP is a preferred non-stick (low surface energy) material for use with the disclosed concept, other materials may be used consistent with aspects of the disclosed concept. For example, a label comprising a layer of a different fluoropolymer may be used. These may include, ethylene tetrafluoroethylene (ETFE), polytetrafluoroethylene (PTFE), polychlorotrifluoroethylene (PCTFE) and perfluoroalkoxy (PFA), among others. Alternatively, a layer that is not a fluoropolymer, but has non-stick surface, i.e., a surface with very low surface energy may be used. Such non-fluoropolymer materials include but are not limited to silicone or aluminum magnesium bromide. Optionally, a non-stick layer according to the disclosed concept, whether or not a fluoropolymer, has a surface energy at or below 24 dynes/cm².

The label 124 further preferably comprises a tie layer 138 between the fluoropolymer layer 132 and polymer layer 136. The tie layer 138 adheres to the fluoropolymer layer 132 and to the polymer layer 136 so as to effectively join them to form the label 124. The tie layer 138 may itself comprise one or more finite layers, but still be referred to as a “layer” in singular form. For example, the tie layer 138 may comprise a double coated polymer film and a synthetic rubber-based adhesive on one or both sides thereof. In one specific example, the tie layer may include a double coated 0.5 mil transparent polyester film and a 1.8-2 mil synthetic rubber-based adhesive. Alternative thicknesses of the tie layer 138 are contemplated.

The polymer layer 136 is optionally about 1-10 mils thick, optionally 1-5 mils thick, optionally 1-2 mils thick but, could be greater than 10 mils if desired. The bonding surface 134 of the polymer layer 136 is adapted to contact and bond with a corresponding interior surface 118, 120 of the storage compartment 122. The polymer layer 136 comprises a polymer material that is compatible with a polymer material of the corresponding interior surface 118,120 (polymer substrate) to which it is adapted to bond. For example, if the interior surface 118,120 comprises polypropylene, the polymer layer 136 also comprises polypropylene. Alternatively, if the interior surface 118,120 comprises polyethylene, the polymer layer 136 also comprises polyethylene. In one optional embodiment, the interior surface 118,120 comprises polypropylene and the polymer layer is a bi-axially oriented polypropylene (“BOPP”) film layer, which is optionally 1-2 mils thick. The BOPP is configured to be compatible with a polypropylene interior surface so as to readily facilitate thermal bonding between the fluoropolymer label 124 and the interior surfaces 118,120 when label 124 is applied thereto. Generically, the BOPP layer in the aforementioned embodiment may be referred to as a “bonding layer” since it contacts and bonds to the container surface when the surface and/or layer are sufficiently heated and then cooled. Alternatively, other biaxially oriented polymers may be used for the polymer layer 136.

The base 108 and sidewalls 110 of the body 102 (and storage space 116) optionally respectfully provide a first interior surface 140 and a second interior surface 142 that meet at a juncture 144. The label 124 bonded to the storage space 116, i.e., the body label 124_{B}, overlays both the first interior surface 140 and the second interior surface 142 such that the body label 124_{B} does not wrinkle substantially, visually or at all, at the juncture 144. This is illustrated in FIG. 4. The lid 104 may include a base 146 that provides interior surface 120. Optionally, base 146 of lid 104 provides a first interior surface 120a of the lid 104 and optionally a depending skirt 148 provides a second interior surface 120b of the lid 104. The first interior surface 120a of the lid 104 and the second interior surface 120b of the lid meet at a juncture 150. The label 124 bonded to the lid 104, i.e., the lid label 124_{L}, overlays both the first interior surface 120a of the lid 104 and the second interior surface 120b of the lid 104, such that the lid label does not wrinkle substantially, visually or at all, at the juncture 150.

Preferably, the body label 124_{B} and lid label 124_{L} permanently bond to corresponding surfaces without the presence of an adhesive between a respective label and respective surface. Preferably, the body label 124_{B} and lid label 124_{L} each consist of a single sheet that covers both a respective first surface and second surface and, which does not include cuts, flaps or the like to transition direction at junctures or corners, in order to cover an entirety of an interior surface. Preferably, the body label 124_{E} and lid label 124_{L} do not require mechanical fasteners to retain the labels 124_{B},124_{L} onto the container 100. Thus, in one aspect, a label 124 according to the disclosed concept is retained onto the container 100 without a mechanical fastener.

Optionally, in any embodiment, the body label 124_{E} and the lid label 124_{L} together cumulatively cover at least 90% of the interior surfaces, optionally at least 95% of the interior surfaces, optionally at least 98% of the interior surfaces, optionally all or substantially all interior surfaces, of the encapsulated storage compartment. In other words, an entirety or substantial entirety of the product contacting surfaces of the storage compartment should be covered with the fluoropolymer label, aside, perhaps, from a negligible amount of storage compartment surface that is exposed due to manufacturing tolerance requirements.

Optionally, as shown in FIGS. 3 and 4, when the container 100 is in the closed position, the skirt 148 engages the sidewalls 110 to provide a seal for the storage compartment 122, so as to substantially isolate the storage compartment 122 from the ambient environment. Alternative sealing means, such as an elastomeric gasket, may be provided. Optionally, the seal is a moisture tight seal which renders the storage compartment moisture tight. As used herein, the term “moisture-tight” is defined as indicating that the moisture ingress of the container and/or the storage compartment (after three days) is less than about 1500 micrograms of water, in another embodiment, about 500 micrograms of water, in a further embodiment, about 300 micrograms of water, in yet another embodiment, about 150 micrograms of water, determined by the following test method: (a) place one gram plus or minus 0.25 grams of molecular sieve desiccant in the container and record the weight; (b) fully close the container; (c) place the closed container in an environmental chamber at conditions of 80% relative humidity and 72 F; (c) after one day, weigh the container containing the molecular sieve; (d) after four days, weigh the container containing the molecular sieve; and (e) subtract the first day sample from the fourth day sample to calculate the moisture ingress of the container in units of micrograms of water.

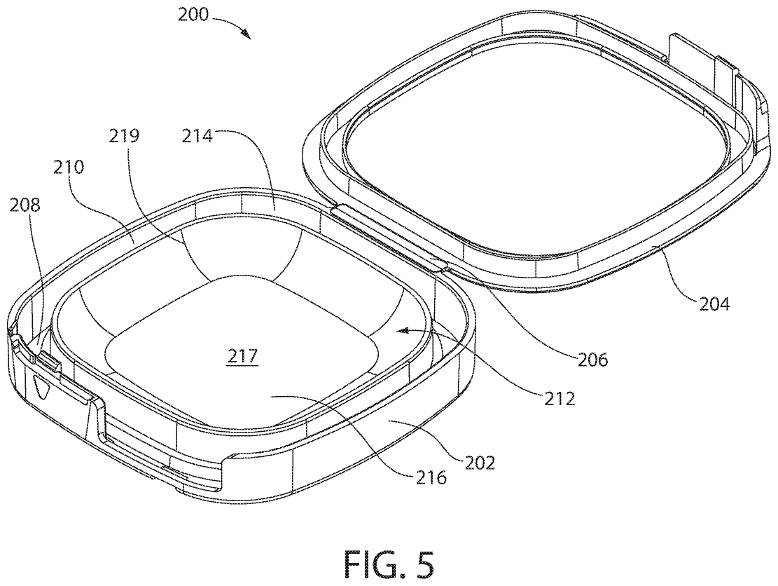

An alternative embodiment of a container 200, in an open position, is shown in FIG. 5. As with the container 100 of FIGS. 1-4, the container 200 includes a body 202 and lid 204 connected thereto by a hinge 206. The body 202 includes a base 208 and sidewalls 210 extending upwards from the base 208 leading to an opening 212. The interior space 214 comprises an internal storage space 216 adapted to house product. Unlike the container 100 of FIGS. 1-4, the internal storage space 216 does not occupy the entirety of the interior space 214. Rather, the internal storage space 216 comprises a storage space base 217 (which may or may not be coplanar with the base 208 of body 202) and interior sidewalls 219 extending therefrom. The interior sidewalls 219 are disposed inward relative to the sidewalls 210 of the body 202. The juncture in this embodiment is more gradual and less abrupt than that of the storage compartment 122 of container 100. Nevertheless, it is necessary to utilize a proper method of placing and bonding the label to the storage compartment to ensure a robust bond substantially without wrinkles, particularly at junctures or corners.

Optionally, the container 100,200 includes a child resistant mechanism to render the container difficult or impossible for young children to open. Optionally, the mechanism may include that disclosed in Applicant's WO 2018/204794, FIGS. 36-48 and the accompanying description, which are incorporated by reference herein in their respective entireties. Briefly, as described therein and shown in FIGS. 1 and 2 of the present application, the body 102 includes a tab 156_{B} extending upwardly and the lid 104 includes a tab 156_{L} extending downwardly. Each tab 156_{B},156_{L} comprises a hook portion 158_{B},158_{L} projecting outwardly from the container 100. Each hook portion 158_{B},158_{L} is configured to interlock with a corresponding edge portion 162_{B},162_{L} of an opening through which the tab 156_{B},156_{L} protrudes.

When container 100 is in the closed position (as shown in FIG. 1), hook portions 158_{B},158_{L} engage respective edge portions 162_{B},162_{L}. In order to open container 100, a user can press button mechanisms 160_{B},160_{L} inwardly. When this happens, tabs 156_{B},156_{L} pivot inwardly. Once tabs 156_{B},156_{L} pivot far enough, hook portions 158_{B},158_{L} clear and disengage from respective edge portions 162_{B},162_{L}. At this point, the child resistant mechanism is disengaged and the lid 104 may be pivoted away from body 102 to open container 100. In this manner, container 100 optionally has a beneficial child resistant senior friendly feature. Other child resistant senior friendly features or mechanisms are also contemplated for use with containers according to the disclosed concept.

As discussed above, internal storage compartment contours can make it difficult for conventional FEP products (e.g., FEP tape) to bond well and lay evenly on internal surfaces of packages, especially when applied via automated processing. This involves a different layer of complexity than is encountered when applying labels (e.g., via in-mold labeling) to exterior surfaces of objects or packages. The various aspects of the disclosed concept presented below are intended to overcome such difficulties.

### Optional In-Mold Label and Pressure Sensitive Processes

Generally, in-mold labeling (IML) or in-mold decorating (IMD) is a process of decorating or labeling injection molded plastic parts or components during the plastic injection molding cycle. The label becomes an integral part of the final product, creating a fully decorated item at press. In this process, a pre-printed label having desirable surface properties is inserted in the open plastic injection mold and held in place via vacuum ports or electrostatic charge, for example. When the mold is closed, plastic resin is injected into the mold, encapsulating the label permanently within the finished part.

The significant difference between pressure sensitive and in-mold label is that the pressure sensitive label is affixed to the surface of the plastic object whereas the in mold label actually becomes an integral part of the molded component. The in mold label is applied at the time of manufacturing the plastic part(s) of container.

The in mold label surface that is being mated with the part or container, meaning the label surface (i.e., bonding layer) with which the molten resin comes into contact, is usually made of the same material as the plastic part or container.

The in mold label is permanent and integral with the product. It will not peel off and cannot be removed by the end user of the product. The accuracy is improved during the time of placement due to robotics positioning into the mold prior to producing the plastic part or container. The in mold label is also flexible and conforms to the shape and texture of the plastic part or container, giving the product more flexibility in product geometry.

The finished labels usually reach the molding site in “cut & stack” state. Picking the label and placing it inside the mold is mostly done automatically, by robot. At this stage the labels must be totally discharged and have the desired coefficient of friction. This way they will not get stuck to each other and pick and place can be performed easily. For injection molding, usually the robot picks the label and charges it up to ˜15 kV, so that it becomes statically charged. This allows the label to be placed inside the mold and remain in position there. Placing vacuum suction tunnels inside the mold, where the label sits, may allow better hold during the molding, if desired. The FEP side of the label faces the cold mold part. When molten plastic is introduced inside the mold at high temperature (for all techniques—injection/blow/thermoforming—the temperature is process and material dependent), only the back side of the label that has the same material property as the molten plastic (few microns) melts and when quickly cooling down, it fuses together with the plastic container or part. After the cycle is complete, the mold opens and the ready part or container is either placed on the conveyor, or picked up again by the robot and stacked on top of the container or part created before it. Once the mold is open and the product is out, the robot quickly places a new label for the next cycle.

The injection molding process includes injecting a heated and molten polymer into a steel mold. With in-mold labeling, the label is placed beforehand inside the same mold. When the label meets the molten polymer inside the mold, they fuse together. The mass then cools off and solidifies into the shape of the mold with the label fused to the container/part wall. Melting and injection temperatures of the plastic are typically in the range of 200° C.-250° C. (depending on the type of plastic). For fast cooling of the material, the steel mold is usually chilled, and thus, the real temperature encountered by the label inside the mold is somewhat lower. The whole process is usually automated and typically lasts up to 5 seconds per injection.

For the exemplary FEP label described above, when applied via in-mold labeling, the thermally bonded substrate allows the smooth application of the label (which may be about 4-6 mils thick) to conform to curved geometries on the surfaces of the container storage compartment.

Adhesion between the bonding layer and the container surface is important. The polyester melt adhesive (e.g., of a tie layer) goes beyond simple chemical adhesion due to the in-mold labelling process. In the embodiment provided above, the temperatures, pressures, and molten BOPP create localized mobility within the adhesive structure allowing for polymer chain entanglement and intercalation forming a tie-layer between the polyester and BOPP. This tie-layer is expected to have enhanced binding strength as observed in higher peel strength and decreased friability in the final part.

Accordingly, the in-mold label technique may uniquely be used to provide an FEP layer to the inside of a container.

According to an exemplary method for applying a fluoropolymer layer to an inside of a container, the method comprises providing a container, e.g., 100. The step of providing the container, in an in-mold label process, would entail injection molding the container in a mold. The method further comprises providing a body label having a first side and a second side opposite the first side, the first side comprising an outer fluoropolymer surface of a fluoropolymer layer, the second side comprising a polymer bonding surface of a polymer layer adapted to contact and bond with the at least one interior surface of the storage space of the container. As discussed above, the body label preferably comprises a tie layer between the fluoropolymer layer and polymer layer. In an in-mold label process, the step of providing a body label would be carried out in the same mold in which the container is injection molded. The method further comprises applying the bonding surface of the body label to at least one interior surface. Through heating the bonding surface and/or the interior surface of the storage space (e.g., during injection molding in an in-mold label process), the body label bonds to the interior surface of the storage space. Upon cooling, the body label is permanently bonded to the interior surface of the storage space. If the container includes a lid, a label may be applied to the lid in a similar fashion.

Optionally, in any embodiment, the label is formed through co-extrusion.

### FEP Thermoform Composite Trays for Insertion into Package

As an alternative to an FEP label, the FEP layer may be applied to a container (e.g., container 100 of FIGS. 1-4) as a thermoform composite tray that is mechanically inserted into the container. An FEP thermoform composite tray would include an FEP layer or label, which is bonded in a thermoform process to another polymer substrate. The polymer substrate may include polypropylene, such as BOPP, or a different polymer material, e.g., nylon or polyethylene. Optionally, the FEP layer and polymer substrate of the tray are formed by co-extrusion.

During thermoforming, unlike the injection molding techniques, the thermoplastic molding material (in web or sheet state) is fed into the molding press. Typically, the molding material is provided as a continuous roll, fed into the molding press. The process uses heat and pressure to shape the material. As with in-mold labeling via injection molding, the label (i.e., FEP layer) is placed inside the mold beforehand; when the label meets the heated polymer inside the mold, they fuse together. The formed composite then cools off and solidifies into the shape of the mold, with the label fused to the container/part wall.

The process temperatures of the plastic for thermoforming are the lowest of all molding processes, being in the range of 130-150° C. (depending on the type of plastic). For fast cooling of the material, the steel mold is usually chilled, and thus, the real temperature encountered by the label inside the mold is somewhat lower. The whole process is usually automated and lasts up to 5 seconds per part.

In short, thermoforming the composite tray may include the following steps: (1) the thermoplastic web/sheet is preheated before entering the mold; (2) an FEP sheet (e.g., 1-2 mils thick) is retained in the mold; (3) the softened plastic enters the mold; (4) the mold closes, shaping the plastic to it; (5) the FEP layer fuses with the plastic; (6) the plastic cools down; (7) the mold opens and a tray is formed comprising a composite of a polymer substrate and FEP layer. As a subsequent step, the FEP thermoform composite tray is mechanically inserted into a container, e.g., 100, to provide a container with an FEP layer on the storage compartment surfaces. Optionally, two different such trays are made—one for the body and one for the lid. Each such tray may be mechanically inserted, respectively, into the body and lid. In this way, substantially the entirety of the product contacting surfaces of the storage compartment can be covered with FEP. Such thermoform composite trays, which form inserts within a package, should address the issue with wrinkling of an FEP layer on the contours of a storage compartment of a package.

### Packaging for Cannabis Extracts or Other Sticky Products

The disclosed concepts could be used, for example, to provide storage for cannabis extracts (e.g., shatter) or other sticky products (which may or may not be derived from cannabis). Optional advantages to using an FEP layer applied according to any process described herein, may include any one or more of the following:

(a) In some applications, cannabis extract may require a high temperature-resistant surface for filling. The FEP has a melt temperature of 500° F. to 536° F., which allows the product to be filled while in a lower temperature-resistant container with a melt temperature of, e.g., 320° F. The FEP film within the rigid container also allows the user access to high resistance to impact and tearing, thus allowing the use of rigid tools to assist in the facilitation of product removal.

(b) Optionally, the FEP layer provides a surface for storage of cannabis extract, which does not stain or result in other markings from contact with the cannabis extract.

(c) Optionally, the FEP layer does not wrinkle or otherwise lay unevenly at junctures between intersecting storage compartment surfaces.

(d) Optionally, the entirety of the storage compartment (which may contact the cannabis extract) is covered with an FEP layer. Optionally, virtually the entirety of the storage compartment is covered with an FEP layer aside from a negligible amount of storage compartment surface that is exposed due to manufacturing tolerance requirements.

(e) Optionally, the FEP-layered storage compartment surfaces of containers according to the disclosed concept have a surface energy at or below 24 dynes/cm².

(f) Optionally, the FEP-layered storage compartment provides a strong barrier, which eliminates product residue and leaching of product into the film.

The following exemplary embodiments further describe optional aspects of the invention and are part of this specification. These exemplary embodiments are set forth in a format substantially akin to claims (each with a numerical designation followed by a letter designation), although they are not technically claims of the present application. The following exemplary embodiments refer to each other in dependent relationships as “embodiments” instead of “claims.”

1A. A container comprising:

a. a body having a base and sidewalls extending upwards from the base leading to an opening, the base and sidewalls forming a storage compartment adapted to house product, the storage compartment having interior surfaces;

b. a lid that is optionally linked to the body by a hinge, the lid being configured to cover the opening to enclose the storage compartment, the lid having at least one interior surface; and

c. a layer of fluorinated ethylene propylene (FEP) covering an entirety or substantial entirety of each of the interior surfaces.

2A. The container of embodiment 1A, the base having an interior surface and each of the sidewalls having an interior surface, wherein the interior surface of the base and the interior surface of each of the sidewalls intersect at a respective juncture and wherein the layer of FEP does not wrinkle at the respective juncture.

3A. The container of embodiments 1A or 2A, wherein the layer of FEP is provided on a label, the label comprising the FEP layer, an adhesive tie layer under the FEP layer and a polymer bonding layer comprising a polymer material configured to thermally bond to the interior surfaces, optionally by an in mold label process or pressure sensitive label process.

4A. The container of any of embodiments 1A to 3A, wherein the layer of FEP is provided on a thermoform composite tray, the thermoform comprising the FEP layer bonded to a polymer substrate to form the thermoform composite tray, the thermoform composite tray being mechanically inserted into the container.

5A. The container of any of embodiments 1A to 4A, wherein the FEP layer is 1-2 mils in thickness.

6A. A method for making a container according to any of embodiments 1A to 4A, comprising in mold labeling the FEP layer to the container during injection molding.

7A. Use of a container according to any of embodiments 1A to 5A for storing cannabis extract which is optionally sticky or tacky.

1B. A method for applying a fluoropolymer layer to an inside of a container, the method comprising:
providing a container comprising a body having a base and sidewalls extending upwards from the base leading to an opening, the base and sidewalls forming an interior space comprising an internal storage space adapted to house product, the storage space having at least one interior surface;
providing a body label having a first side and a second side opposite the first side, the first side comprising an outer fluoropolymer surface of a fluoropolymer layer, the second side comprising a polymer bonding surface of a polymer layer adapted to contact and bond with the at least one interior surface of the storage space, the body label further comprising a tie layer between the fluoropolymer layer and polymer layer; and
applying the bonding surface of the body label to the at least one interior surface and through heating the bonding surface and/or the at least one interior surface of the storage space, causing the body label to bond to the at least one interior surface of the storage space, wherein, upon cooling, the body label is permanently bonded to the interior surface of the storage space.

2B. The method of embodiment 1B, the container further comprising a lid configured to cover the opening when the container is in a closed position.

3B. The method of embodiment 2B, wherein the lid comprises at least one interior surface that encloses the storage space to form a fully encapsulated storage compartment when the container is in the closed position, the method further comprising:
providing a lid label having a first side and a second side opposite the first side, the first side comprising an outer fluoropolymer surface of a fluoropolymer layer, the second side comprising a polymer bonding surface of a polymer layer adapted to contact and bond with the at least one interior surface of the lid; and
applying the bonding surface of the lid label to the at least one interior surface of the lid and through heating the bonding surface and/or the at least one interior surface of the lid, causing the lid label to bond to the at least one interior surface, wherein, upon cooling, the lid label is permanently bonded to the at least one interior surface of the lid.

4B. The method of embodiment 2B or 3B, wherein the lid is linked to the body by a hinge.

5B. The method of any of embodiments 1B to 4B, wherein the fluoropolymer layer of the body label and/or lid label comprises fluorinated ethylene propylene (FEP).

6B. The method of any of embodiments 1B to 5B, wherein the tie layer adheres to the fluoropolymer layer and to the bonding layer, effectively joining them to form the label.

7B. The method of any of embodiments 1B to 6B, wherein the tie layer comprises a double coated polymer film and a synthetic rubber-based adhesive.

8B. The method of any of embodiments 1B to 7B, wherein the polymer layer comprises a polymer material that is compatible with a polymer material of the interior surface so as to facilitate bonding of the label to the interior surface through heating the bonding surface and/or the at least one interior surface.

9B. The method of any of embodiments 1B to 8B, wherein the body label is permanently bonded to the at least one interior surface of the storage space and/or the lid label is permanently bonded to the at least one interior surface of the lid, without the presence of an adhesive between a respective label and a respective surface.

10B. The method of any of embodiments 1B to 9B, wherein the container formed by injection molding during the method and the body label is permanently bonded to the at least one interior surface of the storage space and/or the lid label is permanently bonded to the at least one interior surface of the lid, in an in-mold label process.

11B. The method of any of embodiments 1B to 10B, wherein the body label and lid label together cumulatively cover at least 90% of the interior surfaces, optionally at least 95% of the interior surfaces, optionally at least 98% of the interior surfaces, optionally all or substantially all interior surfaces, of the encapsulated storage compartment.

12B. The method of any of embodiments 1B to 11B, wherein the at least one of the interior surfaces of the storage space includes a first interior surface and a second interior surface that meet at a juncture, wherein the body label overlays both the first interior surface and the second interior surface such that the label does not wrinkle at the juncture.

13B. The method of any of embodiments 1B to 12B, wherein the fluoropolymer layer of the body label and/or lid label is 1-2 mils thick.

14B. A container made according to the method of any of embodiments 3B to 13B.

15B. The container of embodiment 14B, wherein, when in a closed position, the body label and the lid label cover at least 95%, optionally at least 98%, optionally the entirety of the storage compartment.

16B. The container of embodiment 14B or 15B, wherein a portion of the lid, optionally a skirt, engages a portion of the body, optionally sidewalls, to provide a seal for the storage compartment, so as to substantially isolate the storage compartment from the ambient environment.

17B. The container of embodiment 16B, wherein the seal renders the storage compartment moisture tight.

18B. Use of a container according to any of embodiments 14B to 17B for storing cannabis extract.

19B. The use according to embodiment 18B, wherein the cannabis extract is sticky, optionally in the form of a shatter or wax, wherein the surface energy of the outer fluoropolymer surface of the fluoropolymer layer is at or below 24 dynes/cm², so as to provide a surface to which the extract does not adhere.

20B. Use of a container according to any of embodiments 14B to 17B for storing a sticky product, optionally a confection, wherein the surface energy of the outer fluoropolymer surface of the fluoropolymer layer is at or below 24 dynes/cm², so as to provide a surface to which the product does not adhere.

21B. The use according to embodiment 19B or 20B, wherein removal of the extract or product from the storage compartment does not leave residue or other markings on the outer fluoropolymer surface of the fluoropolymer layer.

While the invention has been described in detail and with reference to specific examples thereof, it will be apparent to one skilled in the art that various changes and modifications can be made therein without departing from the spirit and scope thereof.

What is claimed is:

1. An in-mold labeling method for applying a fluoropolymer layer to an inside of a container that is used for storing cannabis extract, the method comprising:
(a) providing a body label inside a mold, the body label having a first side and a second side opposite the first side, the first side comprising an outer fluoropolymer surface of a fluoropolymer layer, the second side comprising a polymer bonding surface of a polymer layer adapted to contact and bond with a compatible polymer substrate upon application of sufficient heat to the polymer bonding surface and/or polymer substrate followed by cooling, the body label further comprising a tie layer between the fluoropolymer layer and polymer layer;
(b) injecting molten thermoplastic resin into the mold to form a container comprising a body having a base and sidewalls extending upwards from the base leading to an opening, the base and sidewalls forming an interior space comprising an internal storage space adapted to house product, the storage space having at least one interior surface; and
(c) in the mold, applying the bonding surface of the body label to the at least one interior surface and through sufficient heating of the bonding surface and/or the at least one interior surface of the storage space followed by cooling, causing the body label to bond to the at least one interior surface of the storage space, wherein, upon cooling, the body label is permanently bonded to the interior surface of the storage space and the body is solid and rigid.

2. The method of claim 1, the container further comprising a lid configured to cover the opening when the container is in a closed position.

3. The method of claim 2, wherein the lid comprises at least one interior surface that encloses the storage space to form a fully encapsulated storage compartment when the container is in the closed position, the method further comprising:
(a) providing a lid label inside the mold or a second mold, the lid label having a first side and a second side opposite the first side, the first side comprising an outer fluoropolymer surface of a fluoropolymer layer, the second side comprising a polymer bonding surface of a polymer layer adapted to contact and bond with a compatible polymer substrate upon application of sufficient heat to the polymer bonding surface and/or polymer substrate followed by cooling, the lid label further comprising a tie layer between the fluoropolymer layer and polymer layer; and
(b) in the mold or the second mold in which the lid label is provided, applying the bonding surface of the lid label to the at least one interior surface of the lid and through sufficient heating of the bonding surface and/or the at least one interior surface of the lid space followed by cooling, causing the lid label to bond to the at least one interior surface of the lid, wherein, upon cooling, the lid label is permanently bonded to the interior surface of the lid and the lid is solid and rigid.

4. The method of claim 2, wherein the lid is linked to the body by a hinge.

5. The method of claim 1, wherein the fluoropolymer layer of the body label and/or lid label comprises fluorinated ethylene propylene (FEP).

6. The method of claim 1, wherein the tie layer adheres to the fluoropolymer layer and to the bonding layer, effectively joining them to form the label.

7. The method of claim 1, wherein the tie layer comprises a double coated polymer film and a synthetic rubber-based adhesive.

8. The method of claim 1, wherein the polymer layer comprises a polymer material that is compatible with a polymer material of the interior surface so as to facilitate bonding of the label to the interior surface through heating the bonding surface and/or the at least one interior surface.

9. The method of claim 1, wherein the body label is permanently bonded to the at least one interior surface of the storage space and/or the lid label is permanently bonded to the at least one interior surface of the lid, without the presence of an adhesive between a respective label and a respective surface.

10. The method of claim 1, wherein the step of injecting molten thermoplastic resin into the mold to form a container is performed after the step of providing a body label inside the mold.

11. The method of claim 3, wherein the body label and lid label together cumulatively cover at least 95% of the interior surfaces of the encapsulated storage compartment.

12. The method of claim 1, wherein the at least one of the interior surfaces of the storage space includes a first interior surface and a second interior surface that meet at a juncture, wherein the body label overlays both the first interior surface and the second interior surface such that the label does not wrinkle at the juncture.

13. The method of claim 1, wherein the fluoropolymer layer of the body label and/or lid label is 0.5-5 mils thick.

14. A container made according to the method of claim 3, into which cannabis extract is stored.

15. The container of claim 14, wherein, when in a closed position, the body label and the lid label cover at least 95% of the storage compartment.

16. The container of claim 14, wherein a skirt of the lid engages the sidewalls of the body, to provide a seal for the storage compartment, so as to substantially isolate the storage compartment from the ambient environment.

17. The container of claim 16, wherein the seal renders the storage compartment moisture tight.

18. The container of claim 14, wherein the cannabis extract is sticky.

19. The container of claim 18, wherein the surface energy of the outer fluoropolymer surface of the fluoropolymer layer is at or below 24 dynes/cm², so as to provide a surface to which the cannabis extract does not adhere.

20. The container of claim 14, wherein the surface energy of the outer fluoropolymer surface of the fluoropolymer layer is at or below 24 dynes/cm², so as to provide a surface to which the cannabis extract does not adhere.

21. The container of claim 20, wherein removal of the cannabis extract from the storage compartment does not leave residue or other markings on the outer fluoropolymer surface of the fluoropolymer layer.

22. The container of claim 14, wherein the at least one of the interior surfaces of the storage space includes a first interior surface and a second interior surface that meet at a juncture, wherein the body label overlays both the first interior surface and the second interior surface such that the label does not wrinkle at the juncture, wherein, when in a closed position, the body label and the lid label cover an entirety of the storage compartment.

23. The container of claim 19, wherein the at least one of the interior surfaces of the storage space includes a first interior surface and a second interior surface that meet at a juncture, wherein the body label overlays both the first interior surface and the second interior surface such that the label does not wrinkle at the juncture, wherein, when in a closed position, the body label and the lid label cover an entirety of the storage compartment, wherein removal of the cannabis extract from the storage compartment does not leave residue or other markings on the outer fluoropolymer surface of the fluoropolymer layer.

24. The container of claim 23, wherein the fluoropolymer layer of the body label and lid label is 0.5-5 mils thick.
